(19) United States
(12) Patent Application Publication
(10) Pub. No.: US 2006/0100729 A1
(43) Pub. Date: May 11, 2006

(54) Method for determination of a lead time

(76) Inventors: Martin Daferner, Sindelfingen (DE); Andreas Heix, Heidelberg (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/533,050

(22) PCT Filed: Sep. 20, 2003
(86) PCT No.: PCT/EP03/10510

§ 371 Date: Aug. 29, 2005

(30) Foreign Application Priority Data
Oct. 29, 2002 (DE) 10250313.3

(51) Int. Cl. G06F 19/00

(52) U.S. Cl. 700/100; 705/28

(57) ABSTRACT

In an exemplary embodiment of the present invention, a method for automatically determining a correction period of time (ΔVLZ_opt) for correcting an actual lead time for delivery of an upstream product (V) which is manufactured with an actual lead time (VLZ_actual) by a delivery unit of a manufacturing network, wherein a quantity of the upstream product (V) to be completed in each case by the delivery unit to cover demand of an end user of the manufacturing network, being determined for multiple points in time and stored in the form of a setpoint delivery curve. The method according to the present invention comprises the steps of, for multiple points in time, determining and storing, in the form of an inventory curve, a quantity of the upstream product (V) completed by the delivery unit but not yet used by a downstream delivery unit, determining the correction period of time (ΔVLZ_opt) by a selection from a quantity of possible periods of time (ΔVLZ), calculating, for each possible period of time, a simulated inventory curve, for each possible period of time using the setpoint delivery curve and the inventory curve, the simulated inventory curve indicating for multiple points in time: a quantity of upstream product (V) that would have been completed by the delivery unit at a particular point in time and not yet used by a downstream delivery unit, if the lead time required by the delivery unit for the upstream product (V) had been altered by the possible period of time in comparison with the actual lead time (VLZ_actual), and selecting as the correction period of time (ΔVLZ_opt) the period of time of the possible periods of time resulting in a simulated inventory curve that is optimal with respect to an optimization criterion (σ) based on the simulated inventory curves. In addition, the present invention provides a device, which can comprises a computer having an internal memory, and a computer program product for automatically determining a correction period of time (ΔVLZ_opt), as determined by the method of the invention.

The present invention relates to a method for automatically determining a correction period of time for correction of an actual lead time for delivery of an upstream product manufactured by a delivery unit of a manufacturing network.

A complex end product such as a motor vehicle is usually manufactured today in an extensive manufacturing network of interconnected delivery units. For example, two delivery units A and B deliver two upstream products V_A and V_B to a downstream delivery unit, which produces an intermediate product using upstream products V_A and V_B. The intermediate product is delivered to another downstream delivery unit or to an end user in the manufacturing network, e.g., a manufacturer of motor vehicles.

The upstream product whose lead time is to be determined is manufactured by a certain delivery unit of the manufacturing network. Inventory of and demand for the upstream product are measured by multiples of a predetermined basic quantity. The basic quantity is, for example, one unit of upstream product. The term “lead time” for a certain upstream product is understood to refer to the period of time elapsing between the completion of a certain quantity of the upstream product by a delivery unit and the use of this quantity by an end user of the manufacturing network. For example, the end user uses the quantity by incorporating intermediate products, manufactured by downstream delivery units using the upstream product, into his end product.

Knowing the correct lead time for the upstream product is a critical factor for the manufacturer of the upstream product as well as for the end user—in particular when the end user's demand fluctuates over time. Fluctuating demand is caused, for example, by demand for the end product that is variable over time or by fabrication of the end product in an individual manner for certain customers, in which the upstream product is used only in some variants of the end product and the end product is fabricated only after receiving a customer order. If the lead time is too long or too short, the delivery unit manufacturing the upstream product will respond too early or too late to changes in demand for the upstream product. There may then be delivery bottlenecks, as a result of which the end user is unable to promptly meet the demand of customers. Or inventories at a delivery unit or at an end user's become greater than necessary, resulting in an increased cost of inventory and associated capital and the risk of damage to the temporarily stored upstream product. In the extreme case, a downstream delivery unit or the end user may no longer be able to use excess upstream products in stock at all, e.g., because production of the end product has been stopped.

Delivery units are expected to respond flexibly to changes in demand and to increase or reduce their production as needed. Therefore, a method for determining the lead time is desired, wherein the period of time between completion by the delivery unit and use by the end user is to be independent of the quantity of upstream product completed.

In a conventional procedure, the “local lead times” between a delivery unit and another delivery unit directly downstream are added up, to thereby determine a lead time for the period of time between completion at a delivery unit and use by the end user. One disadvantage of this procedure, known as the “bullwhip effect,” is described in the article by H. L. Lee, V. Padmanabhan, S. Whang: “The bullwhip effect in the supply chain,” Harvard Business Manager, No. 4 (1997): The variance in order quantities and thus the “local lead times” increases with an increase in the distance between the delivery unit and the end user in the manufacturing network. Only a large interval may be given for the entire lead time between the delivery unit and the end user. The risk is great that too many or too few units of the upstream product will be delivered, which has disadvantages described above and also results in excessive inventories and unnecessary reserve capacity.

U.S. Pat. No. 5,231,567 describes a production scheduling system which determines the lead time from a production capacity and a work demand that is variable over time. The system essentially generates a production schedule including time information. This is done by using a lead time estimate module which determines a lead time from information on manufacturing capacity and demand according to a “lead time estimate command.” In one embodiment, the lead time is varied as a function of altered manufacturing capacity via adjustment data (“capacity adjustment data”). In the single exemplary embodiment which describes how the lead time is determined, a neural network is used, having capacity and demand as input variables and lead time as an output variable. Reference is made to a textbook on the theory of neural networks.

It is known that a neural network is trained with random samples, which in this case include previously determined value pairs for capacity, demand and lead time. To determine the lead time with given values for capacity and demand, a neural network “generalizes” based on the random samples. Lead times from the past are thus extrapolated into the future, even when they have not proven to be optimal. This publication does not describe any method for taking into account improvements on the manufacturing system that would result in a better flow of materials with less disturbance. Another limitation is that estimating the lead time requires a knowledge of the particular manufacturing capacity.

U.S. Pat. No. 5,819,232 describes a method for inventory control. The customer's demand is predicted, and possible fluctuations in demand are also taken into account. An upper and a lower limit are determined for the inventory. The production schedule is set up so that the actual inventory is between the upper and lower limits. The “customer order lead time” is taken into account here and must be known with sufficient accuracy. However, it is not disclosed how this lead time is determined. To be able to implement the method according to U.S. Pat. No. 5,819,232, the lead time must be expressed as a random statistical variable. As in U.S. Pat. No. 5,231,567, random samples are also needed for determination of the parameters of random variables, and lead times are extrapolated from the past into the future.

JP 11175636 describes a simulation system for planning the shipping of goods. To determine a production lead time, a processing time is needed for each individual process (“waiting time”).

JP 00172768 describes a device for determining the minimum inventory level. An upper limit for the lead time is determined and must be maintained in order for the inventory not to fall below a predetermined setpoint inventory level. A maximum and an average shipping volume are derived from this.

JP 08096037 describes a device for determining a schedule (“calendar calculation device”). A composite device for constructing a schedule (“calendar table”) with access to two schedules for calendar days and for date information of working steps generates a composite schedule. A calculation unit then accesses this schedule and a data memory using boundary conditions and generates a calculation result, e.g., a lead time. It is not disclosed how this calculation is performed.

JP 08287149 describes a method for production scheduling. The object is to determine the delay between two successive delivery units. Dates of delivery to the end user and deadlines derived therefrom for completion of upstream products (“passing reference days”) are determined from the delivery date by using measured data. This requires a thorough knowledge of the delivery units, such as which may be available in the case of various delivery units in a corporation, but not in the case of legally independent delivery units.

The object of the present invention is to create a method that will optimize a lead time for an upstream product of a delivery unit in a manufacturing network without requiring a model of the manufacturing network or knowledge of manufacturing capacities. This method should also be applicable when demand for the upstream product is variable over time.

This object is achieved by the method as recited in claim 1, the device as recited in claim 11, and the computer program product as recited in claim 12 or claim 13. Advantageous embodiments are characterized in the subclaims.

According to the present invention, a setpoint delivery curve and an inventory curve are determined. The setpoint delivery curve indicates the quantity of upstream product to be delivered in each case on the basis of the demand by an end user within the manufacturing network for several points in time. The times and quantities of the setpoint delivery curves refer to the delivery unit, e.g., setpoint production capacities, each based on the point in time when the manufactured units of the upstream product leave the manufacturing shop of the delivery unit. The inventory curve gives the quantity of upstream product completed by the delivery unit and not yet used by a downstream delivery unit, for several points in time. A correction period of time for the actual lead time is selected by selecting from a quantity of possible points in time. For each possible period of time, a simulated inventory curve is calculated here. Such a simulated inventory curve for a possible period of time indicates, for multiple points in time, which quantity of upstream product would have been completed by the delivery unit at the particular point in time and not yet used by a downstream delivery unit if the lead time required for the upstream product by the delivery unit had been altered by the period of time in comparison with the actual lead time. The setpoint delivery curve and the inventory curve are used for calculation of such a simulated inventory curve. Of the quantity of possible periods of time, a period of time that is optimal with respect to an optimization criterion is selected as the correction period of time. This optimization criterion is based on the calculated simulated inventory curves. For example, the optimization criterion is the scattering of a simulated inventory curve. The possible period of time is selected as the correction period of time, resulting in a simulated inventory curve having the least scattering of all the simulated inventory curves.

The correction period of time thus determined is optimum for the inventory values and demand values actually in effect and thus the current manufacturing process. This method avoids projecting, generalizing or extrapolating values from the past into the future. It is not necessary to treat the lead time as a statistical random variable or to train a neural network that will predict the lead time. Thanks to the present invention, in particular the optimization criterion, a certain period of time is determined as the lead time automatically and in a reproducible and objective manner.

This method does not require any information about the manufacturing network or other delivery units but instead requires only an inventory curve for the delivery unit which manufactures the upstream product and a setpoint delivery curve from the standpoint of the delivery unit. In addition, it does not require any information or a model, e.g., including individual process steps or periods of time for manufacturing steps in the manufacture of the upstream product or an intermediate or end product in the manufacture of which the upstream product is used. This advantage is manifested in particular when the manufacturing network includes legally independent companies, and the end user is unaware of the details of the manufacturing sequences of a delivery unit. It is not even necessary to know the actual lead time for the upstream product. This method does not require a knowledge of this parameter. However, in another embodiment described below, the actual lead time is determined and used for determining the setpoint delivery curve. The actual lead time is determined, for example, from production protocols, from specifications for the delivery unit or on the basis of an estimate.

The method according to the present invention determines a correction period of time in particular when demand fluctuates about a constant mean, even when the average demand increases or decreases and thus a fitted line through the setpoint delivery curve rises or falls. The latter is the case, for example, when the end user increases production of a new design series or decreases production of an old design series.

In particular since the method does not analyze a model or a neural network, this method requires little computation capacity and little computation time. The information needed for the method according to the present invention is available anyway in mass production in particular.

A preferred embodiment of the method according to the present invention is described in greater detail below on the basis of the accompanying figures, in which

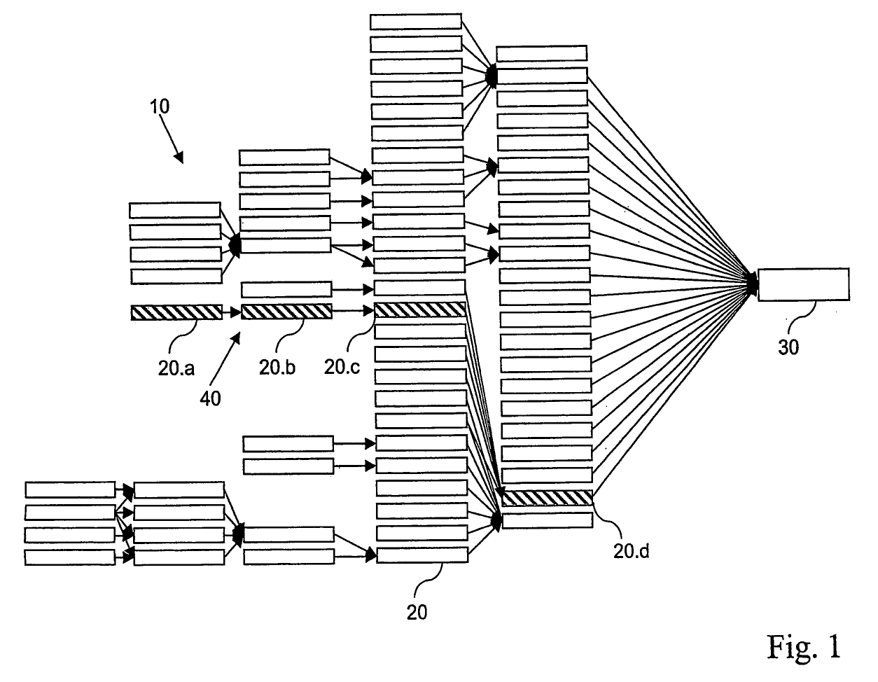

FIG. 1 shows a schematic diagram of a manufacturing network of delivery units;

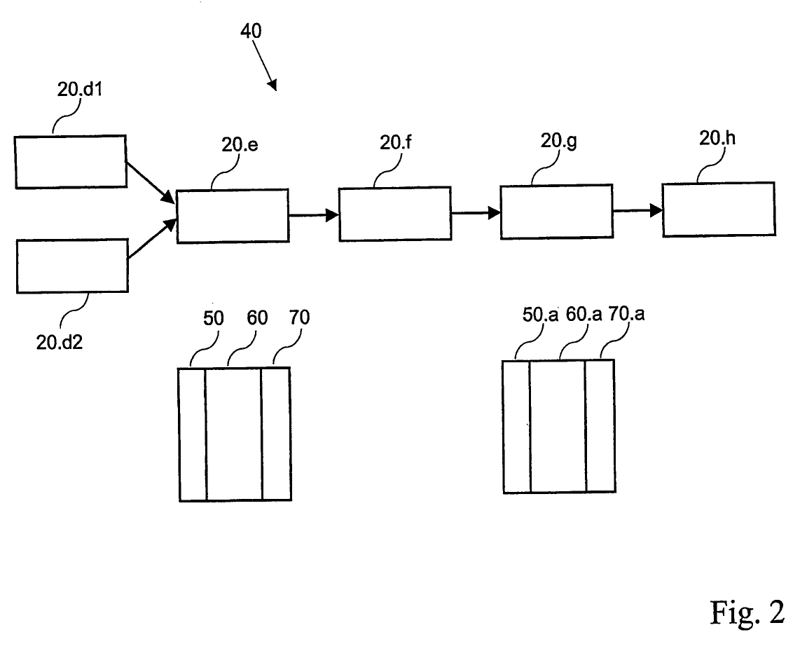

FIG. 2 shows a selected delivery chain in the network of delivery units;

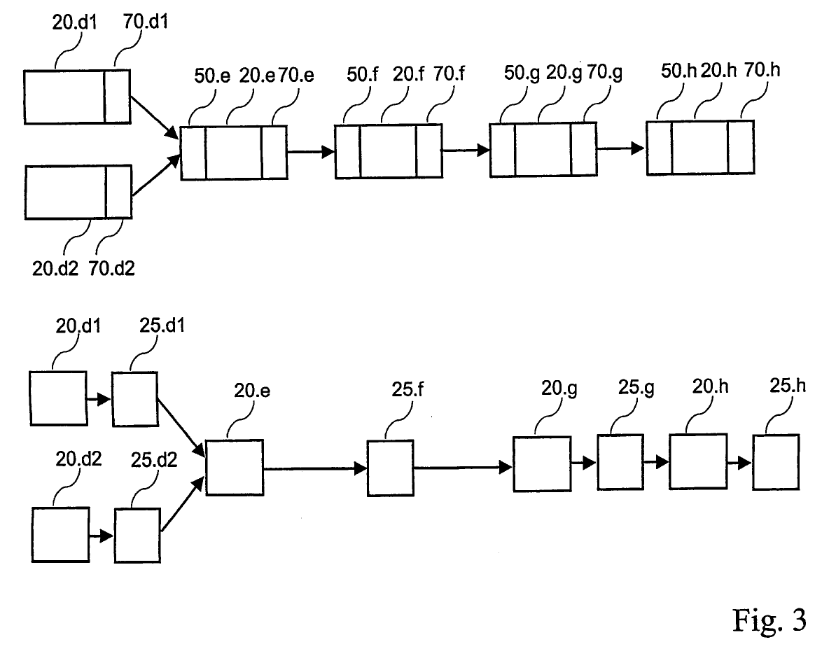

FIG. 3 shows a revised schematic diagram with warehouses encompassing multiple companies;

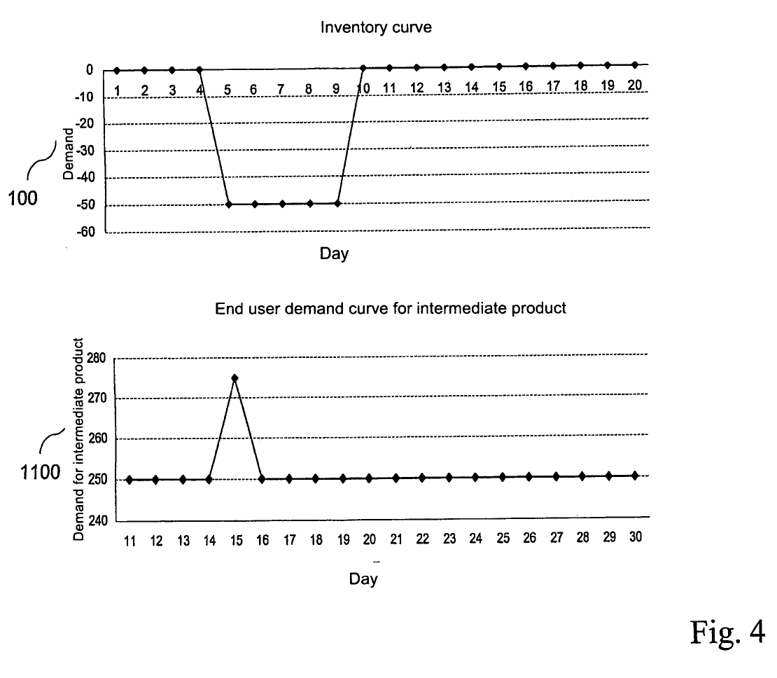

FIG. 4 shows as an example an inventory curve and an end user demand curve for an intermediate product;

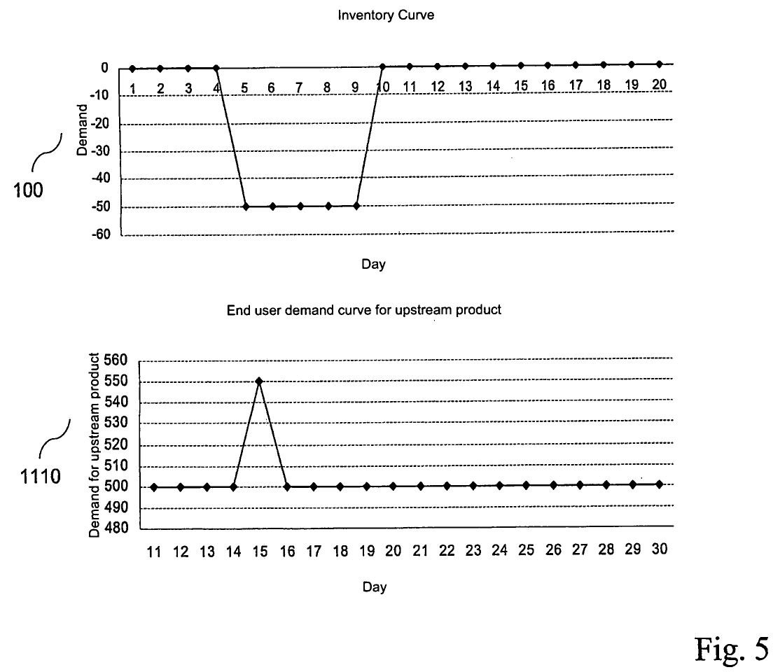

FIG. 5 shows the inventory curve from FIG. 4 and an end user demand curve for the upstream product derived from FIG. 4;

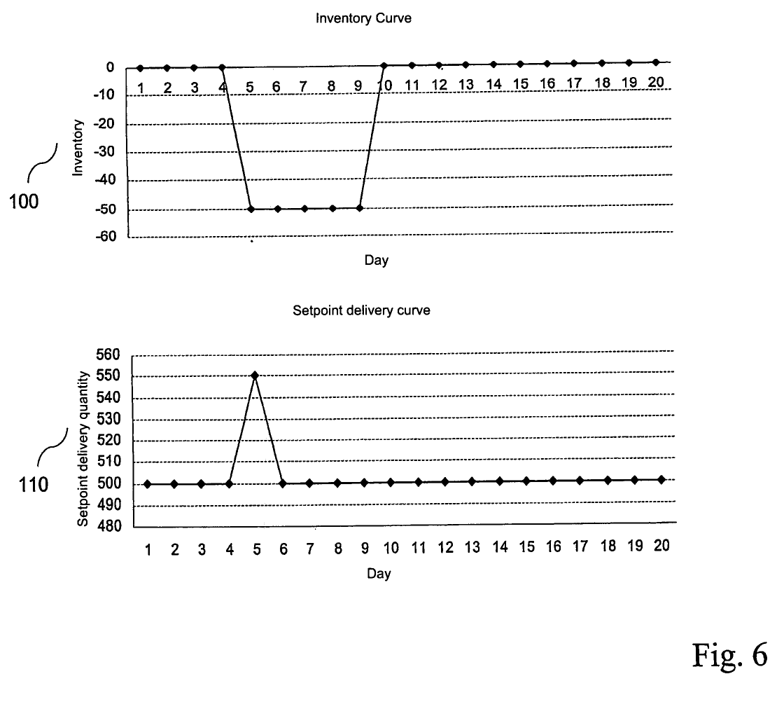

FIG. 6 shows the inventory curve from FIG. 4 and a setpoint delivery curve for the upstream product derived from FIG. 5;

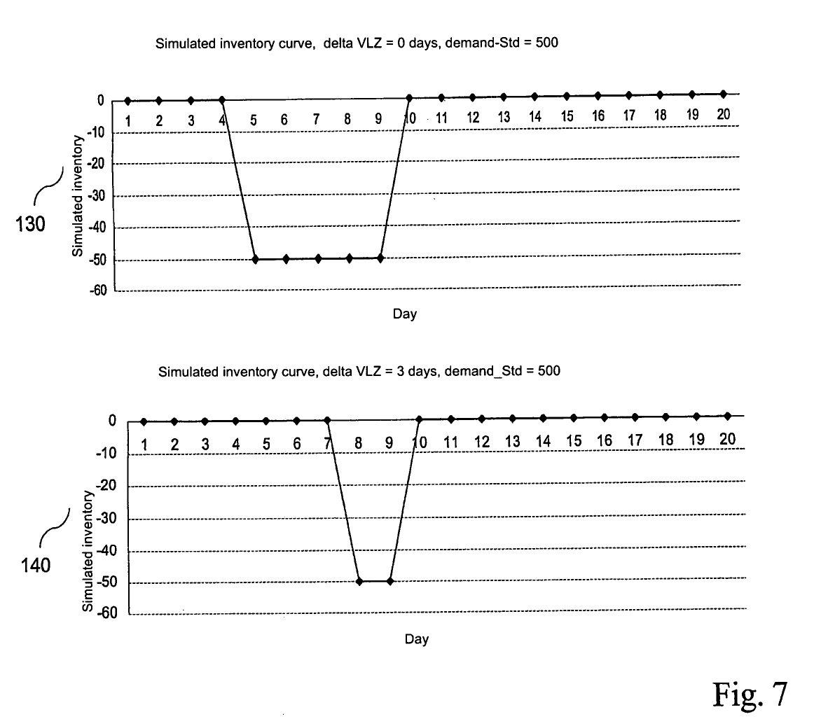

FIG. 7 shows two simulated inventory curves for the possible periods of time of 0 days (top) and 3 days (bottom) on the basis of the setpoint delivery curve and the inventory curve from FIG. 6.

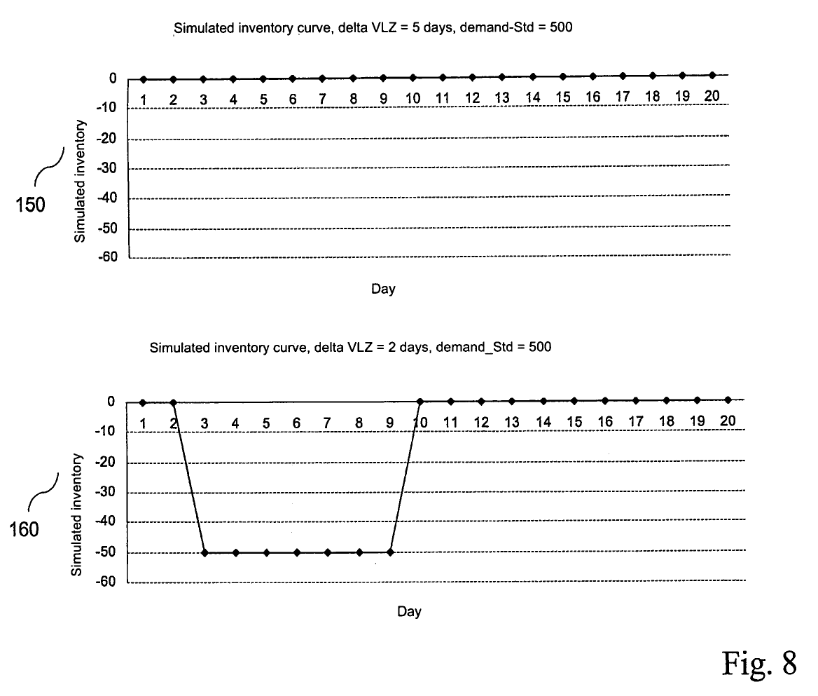

FIG. 8 shows two other simulated inventory curves for the possible periods of time of 5 days (top) and −2 days (bottom) on the basis of the setpoint delivery curve and the inventory curve from FIG. 6.

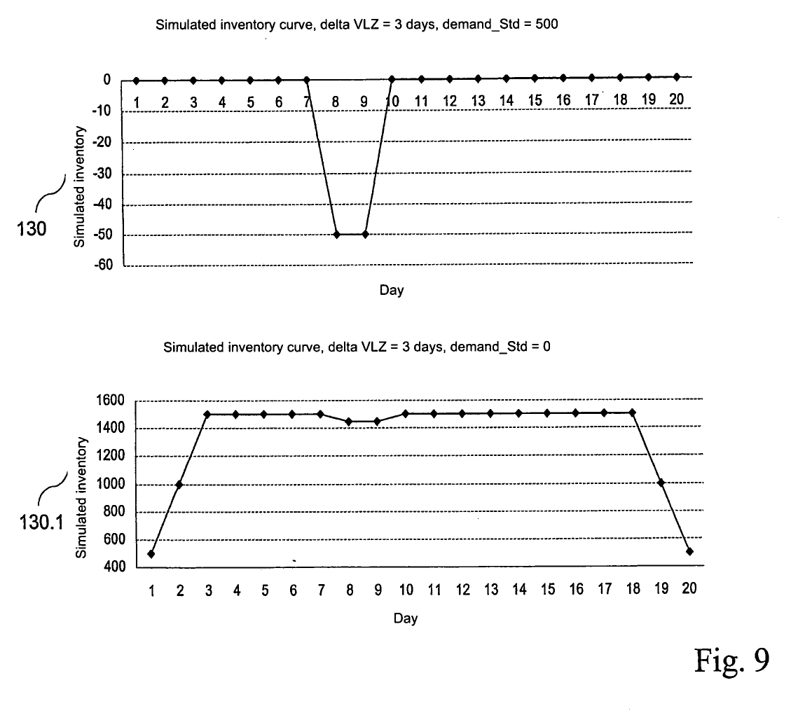

FIG. 9 shows two simulated inventory curves for the possible period of time of 3 days and a standard demand of 500 units (top) or 0 units (bottom).

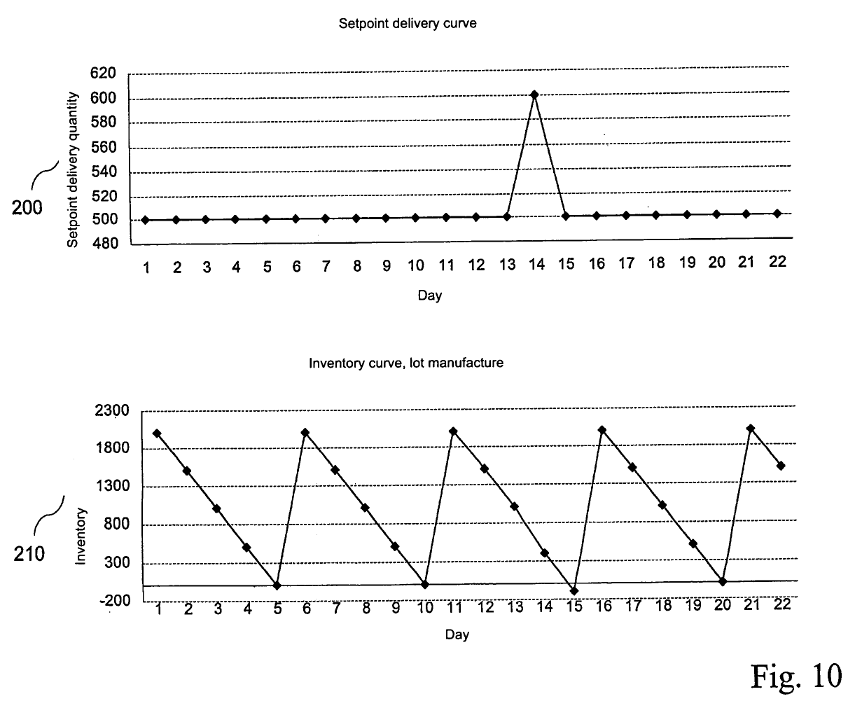

FIG. 10 shows a setpoint delivery curve and an inventory curve in lot size fabrication;

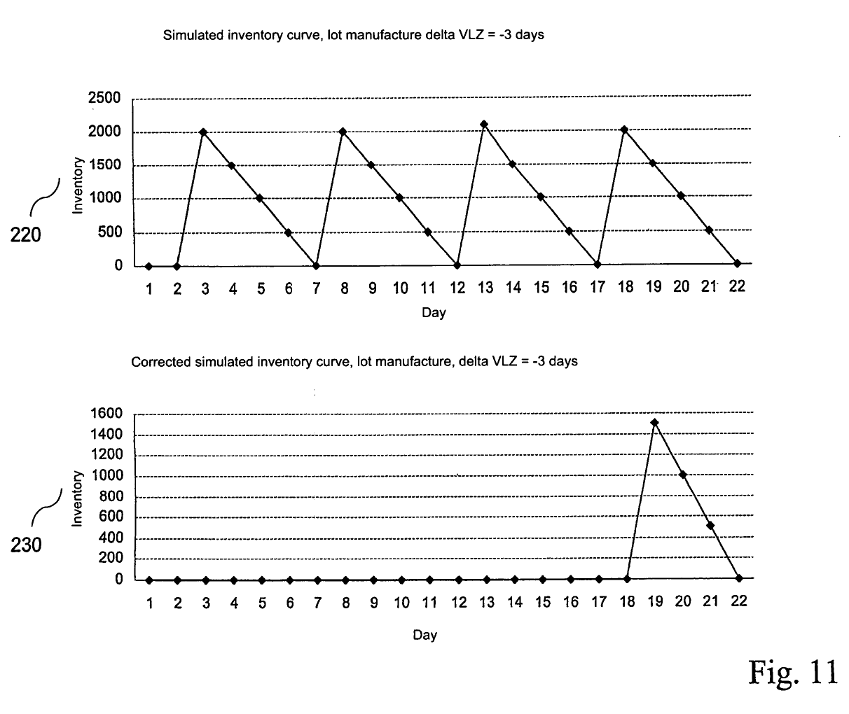

FIG. 11 shows a simulated inventory curve and a simulated inventory curve corrected for the effects of lot size fabrication for the example of FIG. 10.

FIG. 1 shows a diagram of a manufacturing network in which upstream products and intermediate products are manufactured by a network 10 of delivery units 20; these upstream products and intermediate products are used by an end user 30 to fabricate an end product. An end user thus forms a sink in the manufacturing network. Upstream products and intermediate products here include in particular raw materials, semifinished products, components and subsystems of the end product. The term “delivery unit” refers not only to manufacturing shops for physical resources but also service providers. Each delivery unit 20 in this manufacturing network 10 is represented in the form of a box in FIG. 1, where the arrows between the boxes indicate the direction of delivery between delivery units 20. Delivery units jointly supply end user 30, which represents the last link in manufacturing network 10. The plurality of delivery units 20 within manufacturing network 10 are mutually dependent and interlinked in the form of delivery chains 40, one delivery unit 20 supplying goods to the next delivery unit 20 in the delivery sequence. An example of delivery units 20 which jointly form such a delivery chain 40 is represented in FIG. 1 by hatching of the boxes for the delivery units involved. Delivery unit 20.a in the example in FIG. 1 delivers to delivery unit 20.b; delivery unit 20.b in turn delivers to delivery unit 20.c; delivery unit 20.c in turn delivers to delivery unit 20.d and delivery unit 20.d in turn delivers to end user 30. Delivery units 20.a through 20.d together form the delivery chain depicted using hatching in FIG. 1.

When a company supplies a single product or a single service for various consumers, it forms a single delivery unit having a plurality of downstream delivery units. The delivery chain thus branches off at this point. However, if it delivers various products or services to various sites for the manufacturing process, then this company is represented by multiple delivery units in the network.

The method according to the present invention does not necessarily require a knowledge of manufacturing network 10. The information required is explained further below.

FIG. 2 shows a concrete example of a delivery chain 40 composed of a plurality of delivery units 20. This is, for example, the manufacturing process of leather components which are assembled by end user 30 as part of an inside door panel of a passenger vehicle. Delivery chain 40 includes four manufacturing shops 20.d1, 20.d2, 20.e, 20.g, three of which are in South Africa (manufacturing shops 20.d1 (cutting leather blanks for gray leather), 20.d2 (cutting leather blanks for non-gray leather) and 20.e (sewing the leather blanks)), and one of which is in Germany (manufacturing shop 20.g (partial assembly of inside door panel)). In addition, delivery chain 40 includes a shipping company 20.f, which ships the semifinished leather goods from South Africa to Germany, and delivery unit 20.h (final assembly of inside door panel).

As shown in FIG. 2, each delivery unit 20 in this exemplary embodiment has at least one process stage 60 which may include one or more production stages, transport stages, etc. and an output buffer 70. If the delivery unit 20 is supplied by other delivery units, it has at least one input buffer 50. Buffers 50, 70 represent inventories and function to at least partially uncouple the flow of materials between other delivery units 20 in delivery chain 40. For example, input buffer 50.a of manufacturing shop 20.g ensures that manufacturing shop 20.g has access to enough semifinished leather products for partial assembly of the inside door panel until the next delivery. To be able to install inside door panels even when there are delivery problems at manufacturing shops 20.d and 20.e or problems with shipping company 20.f, it may be advisable for manufacturing shop 20.g to design its input buffer 50.a to be larger.

To prevent the determination of the correction period from being made difficult by fluctuations which occur in shipping upstream products and intermediate products, the diagram of the manufacturing network is revised as illustrated in FIG. 3. Such fluctuations may occur, for example, because multiple upstream products or intermediate products are combined into one shipment and shipped together. However, for the determination, it does not matter whether an upstream product or intermediate product is in an output buffer of a delivery unit, on the way between two delivery units, or in the input buffer of a downstream delivery unit. In the diagram of manufacturing network 10, inventories encompassing more than one company are therefore formed by combining the output buffer, shipping delivery units, and input buffers into one warehouse encompassing multiple companies. These embodiments also save on determinations, e.g., determinations of which number of units are in the shipping process and when.

Thus for example output buffer 70.g of delivery unit 20.g and input buffer 50.h of downstream delivery unit 20.h are combined into a warehouse 25.g encompassing multiple companies. In addition, output buffer 70.g of delivery unit 20.g, delivery unit 20.f, which is shipping the goods together with its input buffer 50.f and its output buffer 70.f and input buffer 50.g of downstream delivery unit 20.g are combined into another warehouse 25.f encompassing multiple companies.

For each delivery unit 20 of manufacturing network 10, a correction period of time for the actual lead time may be determined by the method according to the present invention. An embodiment of the method is explained below using the example of delivery unit 20.d1 from FIG. 3. Delivery unit 20.d1 manufactures an upstream product V which is used by downstream delivery units in intermediate products which are in turn used by end user 30 to manufacture the end product. In this example, upstream product V is a gray leather blank for inside door panels.

The method according to the present invention is implemented on a data processing system, e.g., a PC. This data processing system has reading access to data memories in which the values needed for the inventory curve and the values needed for the setpoint delivery curve are stored. The demand values are checked for plausibility and processed as needed. Any missing values are estimated by interpolation, for example.

The method according to the present invention preferably needs the variation of two variables over time, namely the inventory and the demand for upstream product V manufactured by the delivery unit. The curves over time are displayed in an inventory curve and/or in a setpoint delivery curve.

The inventory curve indicates for several points in time the inventory of upstream product V at delivery unit 20.d1; this is the quantity of upstream product V manufactured by the delivery unit (20.d1) but not yet used by a downstream delivery unit.

The quantity is determined in number of units, for example. The inventories are preferably determined at a certain time of day on N successive days. The multiple points in time are thus N successive days. The period of time covered by the N successive days is preferably selected to be large enough so that the method is robust with respect to capacity drops and capacity failures at delivery unit 20.d1. The method according to the present invention may thus be used without changes when the delivery unit manufacturing the upstream product has a drop in capacity. The duration of the drop in capacity is then short in comparison with the period of time covered by the points in time. In mass production in particular, e.g., in the automotive industry, the number of units is recorded over a longer period of time anyway.

The period of time is preferably defined so that it is at least five times longer than the maximum period of time between the occurrence and elimination of a delivery restriction at delivery unit 20.d1, which is manufacturing upstream product V. Typically a drop in capacity of a delivery unit 20 may be eliminated within 10 days, at least according to experience so far. Therefore, at least 5×10 days is selected as the period of time for the inventory curve, so in this case N amounts to at least 60 days.

According to another embodiment, no absolute inventories are given in the inventory curve but instead only the particular change in comparison with an initial value, e.g., an initial inventory or a setpoint inventory or an average inventory or a standard inventory.

The inventory curve preferably refers to a warehouse encompassing multiple companies; in the example in FIG. 3, this is warehouse 25.d1. For implementation of the method, it is not necessary to differentiate how many units of upstream product V are located where in the warehouse encompassing multiple companies. The number of units in the output buffer, transit and downstream input buffer thus need not be differentiated. Instead it is sufficient to determine the total inventory in the warehouse encompassing multiple companies for a period of time and to determine the inventories for each successive point in time by determining the number of incoming units to the input buffer and the number of outgoing units from the output buffer and adding the number of incoming units to the previous inventory and subtracting the number of outgoing units.

The setpoint delivery curve indicates the quantity of upstream product V to be delivered to cover the demand of end user 30 for upstream product V or an intermediate product Z manufactured using upstream product V. This demand refers to a basic period of time, e.g., the demand is given for a certain day. The setpoint delivery curve preferably gives the delivery quantity on N successive days of a period of time, where N and the period of time are determined as described above.

Delivery unit 20.d1 must usually produce a larger quantity of upstream product, e.g., because some units of the upstream product do not have the required quality because downstream delivery units have installed the units in intermediate products of inadequate quality or because individual units of the upstream product or an intermediate product manufactured with the upstream product have been subjected to destructive testing. This “shrinkage” is preferably taken into account by a percentage added to the quantity of upstream product demanded. In the setpoint delivery curve, the increased setpoint delivery quantity is preferably already taken into account.

A setpoint delivery quantity is based on the point in time when delivery unit 20.d1 must have completed upstream product V in order for it to arrive at the downstream delivery units by the scheduled delivery time and ultimately for the demand of end user 30 to be covered. It is possible to determine this demand directly at the delivery unit, e.g., from the setpoint delivery numbers of delivery unit 20.d1.

In contrast, according to a preferred embodiment, an end user demand curve is determined. The demand in this end user demand curve is based on the point in time when end user 30 requires the particular quantity of upstream product—or an intermediate product for whose manufacture the upstream product is needed. In addition, the actual lead time needed by delivery unit 20.d1 for delivery of upstream product V is also determined. This actual lead time is estimated by hand, for example, or is determined from contracts between delivery unit 20.d1 on the one hand and downstream delivery units and/or the end user on the other hand, or is determined approximately from “local lead times” as described above. The setpoint delivery curve is determined with the help of the end user demand curve and the actual lead time.

In the example in FIG. 1 through FIG. 3, end user 30 does not use upstream product V directly but instead uses an intermediate product which delivery unit 20.h manufactures using upstream product V, namely inside door panels. Therefore a parts list is preferably used, indicating the required numbers of upstream products for the end products delivered by end user 30 and/or for the intermediate products used by end user 30. For example, two units of upstream product V, i.e., gray leather blanks, are needed for a gray inside door panel. A motor vehicle requires two inside door panels. For automobiles having gray inside door panels, four units of upstream product V are needed per vehicle.

The end user demand curve indicates the demand for gray inside door panels. With the help of the parts list and the actual lead time, the setpoint delivery curve for upstream product V is generated therefrom. In this example, setpoint delivery curve 110 indicates the number of units of gray leather blanks.

FIG. 4 shows as an example an inventory curve 100 for upstream product V and an end user demand curve 1100 for an intermediate Z supply to end user 30. The segments each refer to a period of time of N=20 days. In this example a certain day, e.g., Mar. 1, 2001, is labeled as day 1. Inventory curve 100 shows the curve of the inventory deviation over time in warehouse 25.d1 encompassing multiple companies for days 1 through 20, i.e., for Mar. 1, 2001 through Mar. 20, 2001. The values show the deviation in inventory based on day 1. On days 5, 6, 7, 8 and 9, the deviation amounts to −50 units of upstream product V, but on all other days, the deviation amounts to 0 units.

End user demand curve 1100 shows the curve of demand over time for end user 30 to an intermediate product supplied to the end user, namely in this example the inside door panel. The demand is plotted for days 11 through 30. These values are determined from existing values for the production of end user 30, for example.

FIG. 5 shows the inventory curve of FIG. 4 and an end user demand curve 1110 for upstream product V, generated with the help of the parts list. End user demand curve 1110 shows the curve of demand by end user 30 for upstream product V over time. The demand is plotted for days 11 through 30. The demand is measured in units of upstream product, namely in this example in units of gray leather. The points in time, i.e., here the days 11 through 30, are the points in time at which the end user needs the intermediate product which is manufactured using the upstream product, namely here gray inside door panels. On day 15, i.e., Mar. 15, 2001, the end user requires so many gray inside door panels that 550 units of gray leather are used to manufacture them.

In this example, the estimated actual lead time for upstream product V is ten days. End user demand curve 1110 for upstream product V is shifted along the time axis by the actual lead time. FIG. 6 shows the result. The demand, here in numbers of units, in setpoint delivery curve 110 is based on the points in time when delivery unit 20.d1 has completed the upstream product, namely leather in this case, and must have delivered it to the downstream delivery units in order for the gray inside door panels to reach the end user in a timely manner.

Preferably a standard demand for upstream product V which is manufactured by delivery unit 20.d1 is also determined. This standard demand is for example the average demand in the last N days.

The correction period of time is determined by the following algorithm in the preferred embodiment. To describe the algorithm, the description means of the pseudo-code are used. The reference notation in pseudo-code has the following meanings:

| | |
|---|---|
| VLZ_actual | The actual lead time which is used as a starting value |
| ΔVLZ | A possible period of time |
| ΔVLZ_opt | The optimum correction period of time to be determined |
| VLZ_opt | The lead time to be determined. VLZ_opt is the sum VLZ_actual + ΔVLZ_opt |
| 1. . . N | The days for which the values of the setpoint delivery curve are |
| | determined and stored |
| Inventory [i] | The inventory in the warehouse encompassing multiple companies on |
| | day i (i = 1, . . . , N), measured in units of upstream product V |
| Inventory [1:N] | The inventory curve for the period of time from day 1 through day N |
| EA demand [j] | The demand of the end user for upstream product V on day j |
| | (j = VLZ_actual + 1, . . . , VLZ_actual + N), measured in units of |
| | upstream product V and for the points in time of delivery to the end user |
| Setpoint quantity [i] | The actual delivery quantity on the basis of the demand of the end user |
| | for upstream product V on day i (i = 1, . . . , N), measured in units of |
| | upstream product V and for the points in time of delivery by the delivery |
| | unit |
| Setpoint | The standard value for the setpoint delivery quantity |
| quantity_Std | |
| [−ΔVLZ_max, . . . | The quantity of possible periods of time for which a simulated inventory |
| ΔVLZ_max] | curve is determined |
| Inventory_sim [i] | Value of the simulated inventory curve for day i (i = 1, . . . N) |
| Inventory_sim [a:b] | The simulated inventory curve for the period of time from day a through |
| | day b (1 ≦ a < b ≦ N) |
| Scattering_min | Minimum scattering in all simulated inventory curves |

```
For i = 1 to N
    Setpoint quantity [i] := EC demand [i + VLZ_actual]
Next i
ΔVLZ_opt := 0
Scattering_min := Scattering (inventory [ΔVLZ_max − 1 : N + 1 −
ΔVLZ_max])
For ΔVLZ = −ΔVLZ_max to ΔVLZ_max
    For i = 1 to N
        Inventory_sim [i] := Inventory [i]
    Next i
    If ΔVLZ > 0, then
        For i = 1 to N
            Sum := 0
            For k = 0 to ΔVLZ − 1
                If i − k > 0, then
                  Sum :=
                  Sum + (setpoint quantity [i − k] −
                  setpoint quantity_Std)
                End if
            Next k
            Inventory_sim [i] := inventory_sim [i] + sum
        Next i
    End if
    If ΔVLZ < 0, then
        For i = 1 to N
            Sum := 0
            For k = ΔVLZ to − 1
                If i − k ≦N, then
                  Sum :=
                  Sum + (setpoint quantity [i − k] −
                  setpoint quantity_Std)
                End if
            Next k
            Inventory_sim [i] := inventory_sim [i] − Sum
        Next i
    End If
    Scattering_new :=
    Scattering (inventory_sim [ΔVLZ_max − 1 : N + 1 − ΔVLZ_max])
    If scattering_min > scattering_new, then
        Scattering_min := scattering_new
        ΔVLZ_opt := ΔVLZ
    End If
Next ΔVLZ
VLZ_opt := VLZ_actual + ΔVLZ_opt
```

The scattering, often also the standard deviation of a measured value series (x1, . . . , xN), is determined according to the formula

$$σ = \sqrt{\frac{1}{N - 1} {\sum }_{i - 1}^{N} {( xi - μ N )}^{2}}$$

where

$$μ = \frac{1}{N} {\sum }_{x = 1}^{N} xi$$

is the mean of the measured values (x1, . . . , xN).

Instead of scattering, other optimization criteria based on the simulated inventory curves may also be used. For example, a simulated inventory curve is weighted according to one of the formulas

$$Bew = \sqrt[k]{\frac{1}{N - 1} {\sum }_{i = 1}^{N} {\vert {x}_{i} - {μ}_{N} \vert}^{k}}$$

where k is a positive number or
Bew=max {|xi−xj|, so that i=1, . . . , N and j=1, . . . , N}. If all the values of the simulated inventory curve are identical, then Bew=0. The possible period of time resulting in the simulated inventory curve with the lowest weighting Bew is selected as the correction period of time. It is also possible for the value 0 to be determined as the correction period of time. The actual lead time is then already optimal.

All the optimization criteria listed above result in selection of the correction period of time which yields the least fluctuation in the inventory of upstream product V at delivery unit 20.d1, which manufactures the upstream product.

FIG. 7 and FIG. 8 show four simulated inventory curves for the inventory curve and the setpoint delivery curve from FIG. 6. In this example N=20 days and ΔVLZ_max=5. The quantity of possible periods of time is thus the interval (−5 days, +5 days) around the actual lead time VLZ_actual=10 days.

FIG. 7 shows a simulated inventory curve 130 for ΔVLZ=0 days at the top and a simulated inventory curve 140 for ΔVLZ=3 days at the bottom. FIG. 8 shows a simulated inventory curve 150 for ΔVLZ=5 days at the top and a simulated inventory curve 160 for ΔVLZ=−2 days at the bottom. In all four cases the standard demand is 500 units. Scattering σ in simulated inventory curve 130 in FIG. 7 amounts to σ=25.75 while the scattering in simulated inventory curve 140 is σ=19.46. Scattering a in simulated inventory curve 150 in FIG. 8 is σ=0, while the scattering of simulated inventory curve 160 is σ=25.62. The method according to the present invention yields a correction period of time of ΔVLZ_opt=5 days and thus a lead time VLZ_opt=VLZ_actual+ΔVLZ_opt=10+5=15 days.

FIG. 9 and the table below illustrate how the method according to the present invention yields the same result when a different value is preselected for the standard demand.

| | Simulated | Simulated |
|---|---|---|
| | inventory curve | inventory curve |
| Day | Standard demand = 500 | Standard demand = 0 |
| 1 | 0 | 500 |
| 2 | 0 | 100 |
| 3 | 0 | 1500 |
| 4 | 0 | 1500 |
| 5 | 0 | 1500 |
| 6 | 0 | 1500 |
| 7 | 0 | 1500 |
| 8 | −50 | 1450 |
| 9 | −50 | 1450 |
| 10 | 0 | 1500 |
| 11 | 0 | 1500 |
| 12 | 0 | 1500 |
| 13 | 0 | 1500 |
| 14 | 0 | 1500 |
| 15 | 0 | 1500 |
| 16 | 0 | 1500 |
| 17 | 0 | 1500 |
| 18 | 0 | 1500 |
| 19 | 0 | 1000 |
| 20 | 0 | 500 |

The first (ΔVLZ_max−1) values, namely in this example the first four values, are not taken into account in calculating the scattering, so this yields the same scattering σ=19.46 for simulated inventory curves 130 and 130.1. Essentially the scattering or the other optimization criteria described above do not depend on the value of the standard demand.

A refinement of the present invention is used when upstream product V is fabricated in lots. With lot fabrication, a lot which is a multiple of a basic quantity of upstream product, e.g., a certain number of units of upstream product, is fabricated once and sent to the warehouse at a certain point in time. A lot covers the demand of a downstream delivery unit for upstream product V for all points in time until the completion of the next lot. Lot fabrication is described, for example, by H. Tempelmeier: “Material-Logistik: Grundlagen der Bedarfs- und Losgröβenplanung in PPS-Systemen” [Material Logistics: Principles of Demand and Lot Size Planning in PPS Systems], Springer-Verlag, Berlin and Heidelberg, 1995.

FIG. 10 shows as an example another setpoint delivery curve 200 and an inventory curve 210 in lot fabrication. In this example, one lot is fabricated on each of days 1, 6, 11, 16 and 21. Inventory curve 210 has a sawtooth curve because units of upstream product V are removed from warehouse 25.d1 each day but this warehouse is filled up only once every five days. The embodiment of the method does not presuppose that the lots are completed at equal intervals, e.g., every five days.

The lead time correction period of time is determined by the algorithm given below in this refinement, which takes into account lot fabrication. This algorithm is also described with the help of the description means of the pseudo-code. The additional reference notation in the pseudo-code has the following meanings:

| | |
|---|---|
| M | The number of lot completion points in time in |
| | days 1, . . . , N |
| LFZ [1], . . . , LFZ [M] | Lot completion points in time in |
| | days 1, . . . , N |
| Inventory_sim_ber | Value of the corrected simulated inventory |
| | curve on day i (i = 1, . . . , N), measured |
| | in units of upstream product V |

In the example in FIG. 10, M=5, LFZ[1]=1, LFZ[2]=6, LFZ[3]=11, LFZ[4]=16 and LFZ[5]=21.

```
ΔVLZ_opt := 0
Scattering_min := Scattering (Inventory [ΔVLZ_max − 1 : N + 1 −
ΔVLZ_max])
For ΔVLZ = −ΔVLZ_max to ΔVLZ_max
    For i = 1 to N
        Inventory_sim [i] := 0
    Next i
    For j = 1 to M
        Inventory_sim [LFZ [j] + ΔVLZ] :=
        Inventory [LFZ [j]] + setpoint quantity [LFZ [j]] −
        Inventory [LFZ [j] − 1]
        Inventory_sim [LFZ [j] + ΔVLZ] :=
        Inventory_sim [LFZ [j] + ΔVLZ] − setpoint quantity [LFZ [j] +
        ΔVLZ] + Inventory_sim [LFZ [j] + ΔVLZ − 1]
        For k = LFZ [j] + 1 to LFZ [j + 1] − 1
            Inventory_sim [k + ΔVLZ] :=
            Inventory_sim [k − 1 + ΔVLZ] − setpoint quantity [k +
            ΔVLZ]
        Next k
        For k = LFZ [j] to LFZ [j + 1] − 1
            Inventory_sim_ber [k + ΔVLZ] := inventory_sim [k +
            ΔVLZ]
            For u = k + 1 to LKZ [j + 1] − 1
                Inventory_sim_ber [k + ΔVLZ] :=
                Inventory_sim_ber [k + ΔVLZ] −
                setpoint quantity [u + ΔVLZ]
            Next u
        Next k
    Next j
    Scattering_new :=
    Scattering (inventory_sim [ΔVLZ_max − 1 : N + 1 − ΔVLZ_max])
    If Scattering_min > scattering_new, then
        Scattering_min := scattering_new
        ΔVLZ_opt := ΔVLZ
    End If
Next ΔVLZ
VLZ_opt := VLZ_actual + ΔVLZ_opt
```

FIG. 11 shows simulated inventory curve 220 and corrected simulated inventory curve 230 for the example from FIG. 10 and for the possible period of time of −3 days. Again in this example, ΔVLZ_max=5 days, so the first four values and the last four values of the corrected simulated inventory curve are not taken into account in calculating the scattering. Therefore, the scattering is 0 for ΔVLZ=−3 days, so that ΔVLZ_opt=−3 days and VLZ_opt=10+(−3)=7 days.

In summary, the present invention relates to a method for automatically determining a correction period of time for correcting an actual lead time for the delivery of an upstream product which is manufactured by a delivery unit of a manufacturing network. According to the present invention, a setpoint delivery curve and an inventory curve are determined. The setpoint delivery curve indicates the quantity of upstream product required by an end user of the manufacturing network in each case; the inventory curve indicates the quantity of upstream product completed by the delivery unit but not yet delivered. The correction period of time is selected by optimization over a quantity of possible periods of time. To do so, a simulated inventory curve is calculated for each possible period of time. Such a simulated inventory curve for a possible period of time indicates, for multiple points in time, which quantity of upstream product would have been completed by the delivery unit at the particular point in time and not yet delivered if the lead time required by the delivery unit for the upstream product had been altered by the possible period of time in comparison with the actual lead time. For example, the scattering in the simulated inventory curves over time may be used as an optimization criterion.

### LIST OF REFERENCE NUMERALS

| Numeral | Meaning |
|---|---|
| 10 | Network of delivery units |
| 20, 20.a, 20.b, . . . | Delivery units |
| 25.d1, 25.d2, . . . | Warehouses encompassing multiple companies |
| 30 | End user of network 10 |
| 40 | Delivery chain |
| 50.a, 50.b, . . . | Input buffer of delivery units |
| 60, 60.a | Process stages of delivery units |
| 70.a, 70.b, . . . | Output buffer of delivery units |
| 100 | Inventory curve for warehouse encompassing |
| | multiple companies |
| 110, 200 | Setpoint delivery curve |
| 130, 130.1, 140, | Simulated inventory curves |
| 150, 160 | |
| 210 | Inventory curve with lot size fabrication |
| 220 | Simulated inventory curve in lot size fabrication |
| 230 | Corrected simulated inventory curve in lot size |
| | fabrication |
| 1100 | End user demand curve for intermediate product Z |
| 1110 | End user demand curve for upstream product V |

1-13. (canceled)

14. A method for automatically determining a correction period of time (ΔVLZ_opt) for correcting an actual lead time for delivery of an upstream product (V) which is manufactured with an actual lead time (VLZ_actual) by a delivery unit of a manufacturing network, wherein a quantity of the upstream product (V) to be completed in each case by the delivery unit to cover demand of an end user of the manufacturing network being determined for multiple points in time and stored in the form of a setpoint delivery curve, the method comprising the steps of:
for multiple points in time, determining and storing, in the form of an inventory curve, a quantity of the upstream product (V) completed by the delivery unit but not yet used by a downstream delivery unit;
determining the correction period of time (ΔVLZ_opt) by a selection from a quantity of possible periods of time (ΔVLZ),
calculating, for each possible period of time, a simulated inventory curve, for each possible period of time using the setpoint delivery curve and the inventory curve,
the simulated inventory curve indicating for multiple points in time:
a quantity of upstream product (V) that would have been completed by the delivery unit at a particular point in time and not yet used by a downstream delivery unit,
if the lead time required by the delivery unit for the upstream product (V) had been altered by the possible period of time in comparison with the actual lead time (VLZ_actual), and
selecting as the correction period of time (ΔVLZ_opt) the period of time of the possible periods of time resulting in a simulated inventory curve that is optimal with respect to an optimization criterion (σ) based on the simulated inventory curves.

15. The method of claim 14, comprising the further steps of:
determining an actual lead time (VLZ_actual) for the upstream product (V), and
determining a setpoint lead time (VLZ_opt) for the upstream product (V) as the sum of the actual lead time (VLZ_actual) and the correction period of time (ΔVLZ_opt).

16. The method of claim 14, wherein the optimization criterion is minimizing the scattering in the simulation inventory curves.

17. The method of claim 14, wherein the step of determining the completed but not yet used quantities of the upstream product (V), is carried out by determining and adding up the inventories of the upstream product (V) in an output buffer of the delivery unit the inventories in transit to the downstream delivery units and the inventories in an input buffer of the downstream delivery unit are determined and added up.

18. The method of claim 14 wherein the step of determining the quantity of the upstream product (V) needed by the end user (30), is carried out by determining a quantity of at least one intermediate product (Z) for the manufacture of which the upstream product (V) is used and which is delivered by another delivery unit of the manufacturing network directly to the end user, and using a parts list including the intermediate product (Z) and the upstream product (V).

19. The method of claim 14, wherein
the multiple points in time for the setpoint delivery curve are multiple successive days from a first period of time that has been defined,
the multiple points in time for the inventory curve are multiple successive days from the first or a second period of time that has been defined, and
both periods of time are each at least five times as long as the maximum period of time between the occurrence and elimination of a delivery restriction at the delivery unit manufacturing the upstream product (V).

20. The method of claim 14, comprising the further steps of:
determining the quantity of the upstream product (V) required by the end user and storing the quantity in the form of an end user demand curve for the upstream product (V),
determining an actual lead time (VLZ_actual) for the upstream product, and
determining the setpoint delivery curve by shifting the end user demand curve along the time axis by the actual lead time (VLZ_actual).

21. The method of claim 20, comprising the further steps of:
determining a quantity of an intermediate product (Z) required by the end user (30), for the manufacture of which the upstream product (V) is used, and storing the quantity in the form of an end user demand curve for the intermediate product (Z),
using a parts list, determining the number of units of the upstream product (V) needed for the manufacture of one unit of an intermediate product (Z), and
determining an end user demand curve for the upstream product as a function of the end user demand curve for the intermediate product and the parts list.

22. The method of claim 14,
wherein the upstream product is fabricated in lots, each including a multiple of a basic quantity, and comprising the further step of:
for each possible period of time, calculating the effects of lot fabrication as a function of the simulated inventory curve for calculating a simulated inventory curve and a corrected simulated inventory curve, and wherein the optimization criterion (σ) is based on the corrected simulated inventory curve.

23. The method of claim 22, as recited in claim 22, comprising the further steps of:
in extrapolating the effects of lot fabrication, analyzing the simulated inventory curve to determine the points in time (LFZ [1], LFZ [2], . . . ) at which a lot has been completed, and for a point in time between two lot completion points in time (LFZ [1], LFZ [2], . . . ), the values of the setpoint delivery curve for all subsequent points in time until the last point in time before the next lot completion point in time are subtracted from the value of the simulated inventory curve.

24. A device for performing the method for automatically determining a correction period of time (ΔVLZ_opt) for correcting an actual lead time for delivery of an upstream product (V) which is manufactured with an actual lead time (VLZ_actual) by a delivery unit of a manufacturing network, wherein a quantity of the upstream product (V) to be completed in each case by the delivery unit to cover demand of an end user of the manufacturing network being determined for multiple points in time and stored in the form of a setpoint delivery curve, the device comprising:
an apparatus for determining and storing an inventory curve,
an apparatus for determining simulated inventory curves,
and an apparatus for determining the correction period of time (ΔVLZ_opt) by selection of the optimum period of time (ΔVLZ_opt) according to an optimization criterion (σ) based on the simulated inventory curves from the quantity of possible periods of time (ΔVLZ).

25. A computer program product arranged and configured to be loaded into an internal memory of a computer and which includes software segments for implementing, when the product is running on the computer, a method for automatically determining a correction period of time (ΔVLZ_opt) for correcting an actual lead time for delivery of an upstream product (V) which is manufactured with an actual lead time (VLZ_actual) by a delivery unit of a manufacturing network, wherein a quantity of the upstream product (V) to be completed in each case by the delivery unit to cover demand of an end user of the manufacturing network being determined for multiple points in time and stored in the form of a setpoint delivery curve, the method comprising the steps of:
for multiple points in time, determining and storing, in the form of an inventory curve, a quantity of the upstream product (V) completed by the delivery unit but not yet used by a downstream delivery unit;
determining the correction period of time (ΔVLZ_opt) by a selection from a quantity of possible periods of time (ΔVLZ),
calculating, for each possible period of time, a simulated inventory curve, for each possible period of time using the setpoint delivery curve and the inventory curve,
the simulated inventory curve indicating for multiple points in time:
a quantity of upstream product (V) that would have been completed by the delivery unit at a particular point in time and not yet used by a downstream delivery unit,
if the lead time required by the delivery unit for the upstream product (V) had been altered by the possible period of time in comparison with the actual lead time (VLZ_actual), and
selecting as the correction period of time (ΔVLZ_opt) the period of time of the possible periods of time resulting in a simulated inventory curve that is optimal with respect to an optimization criterion (σ) based on the simulated inventory curves.

26. A computer program product stored on a computer-readable medium and including a computer readable program arranged and configured to cause a computer to execute a method for automatically determining a correction period of time (ΔVLZ_opt) for correcting an actual lead time for delivery of an upstream product (V) which is manufactured with an actual lead time (VLZ_actual) by a delivery unit of a manufacturing network, wherein a quantity of the upstream product (V) to be completed in each case by the delivery unit to cover demand of an end user of the manufacturing network being determined for multiple points in time and stored in the form of a setpoint delivery curve, the method comprising the steps of:
for multiple points in time, determining and storing, in the form of an inventory curve, a quantity of the upstream product (V) completed by the delivery unit but not yet used by a downstream delivery unit;
determining the correction period of time (ΔVLZ_opt) by a selection from a quantity of possible periods of time (ΔVLZ),
calculating, for each possible period of time, a simulated inventory curve, for each possible period of time using the setpoint delivery curve and the inventory curve,
the simulated inventory curve indicating for multiple points in time:
a quantity of upstream product (V) that would have been completed by the delivery unit at a particular point in time and not yet used by a downstream delivery unit,
if the lead time required by the delivery unit for the upstream product (V) had been altered by the possible period of time in comparison with the actual lead time (VLZ_actual), and
selecting as the correction period of time (ΔVLZ_opt) the period of time of the possible periods of time resulting in a simulated inventory curve that is optimal with respect to an optimization criterion (σ) based on the simulated inventory curves.
